(19) United States
(12) Patent Application Publication
(10) Pub. No.: US 2013/0160531 A1
(43) Pub. Date: Jun. 27, 2013

(54) SENSOR DEVICE

(71) Applicant: AISAN KOGYO KABUSHIKI KAISHA, Aichi-ken (JP)

(72) Inventor: Nobuhiro Kato, Aichi-ken (JP)

(73) Assignee: AISAN KOGYO KABUSHIKI KAISHA, Aichi-ken (JP)

(21) Appl. No.: 13/725,387

(22) Filed: Dec. 21, 2012

(30) Foreign Application Priority Data
Dec. 27, 2011 (JP) 2011-286234

(51) Int. Cl. G01N 25/00

(52) U.S. Cl. CPC G01N 25/00
USPC 73/61.76

(57) ABSTRACT

A sensor device may be configured to detect a level of liquid, a concentration of a specific substance included in the liquid, and a temperature of the liquid. The sensor device may comprise a substrate, a level electrode configured to be disposed on the substrate and detect the level, an electrode for liquid quality configured to be disposed on the substrate and detect the concentration, a temperature electrode configured to be disposed on the substrate and detect the temperature, and a reference electrode configured to be disposed on the substrate and maintain a reference electric potential. The reference electrode may be disposed at least between two of the level electrode, the electrode for liquid quality and the temperature electrode.

### CROSS-REFERENCE TO RELATED APPLICATIONS

This application claims priority to Japanese Patent Application No. 2011-286234, filed on Dec. 27, 2011, the contents of which are hereby incorporated by reference into the present application.

### TECHNICAL FIELD

The specification discloses a sensor device for detecting a level of liquid, a concentration of a specific substance in the liquid, and a temperature of the liquid.

### DESCRIPTION OF RELATED ART

Japanese Patent Application Publication No. S63-79016 discloses a sensor device in which a pair of level electrodes for detecting a level of fuel is disposed on a substrate. In this sensor device, the level is specified using an electrostatic capacitance between the pair of level electrodes. The electrostatic capacitance between the pair of level electrodes changes with the level of the liquid and changes with permittivity of the liquid. In this sensor device, a pair of permittivity electrodes for detecting the permittivity of the liquid is disposed on the substrate in addition to the pair of level electrodes. A ground electrode is disposed between the pair of level electrodes and the pair of permittivity electrodes.

### SUMMARY

In a case where the liquid to be detected is a mixture of a plurality of sorts of substances, the permittivity of the liquid changes the contents (that is, the concentration of substance) of the plurality of sorts of substances included in the liquid. Further, the permittivity of liquid changes with the temperature of the liquid. Thus, in order to appropriately specify the level of the liquid and the concentration of a specific substance in the liquid, it is necessary to specify the temperature of the liquid.

Since the sensor device is disposed in a container (e.g., within a fuel tank) that stores liquid, it is preferable to decrease the size of the sensor device as much as possible. On the other band, when respective electrodes are disposed adjacently in order to decrease the size of the sensor device, an unnecessary electrostatic capacitance (i.e., stray capacitance or parasitic capacitance) occurs between the respective electrodes, and detection accuracy decreases. Therefore, this specification provides a sensor device in which electrodes for specifying the level of liquid, the concentration of a specific substance in the liquid, and the temperature of the liquid are appropriately disposed on one substrate.

The technique disclosed herein is a selnsor device configured to detect a level of liquid, a concentration of a specific substance included in the liquid, and a temperature of the liquid. The sensor device may comprise a substrate, a level electrode, an electrode for liquid quality, a temperature electrode and a reference electrode. The level electrode may be configured to be disposed on the substrate and detect the level. The electrode for liquid quality may be configured to be disposed on the substrate and detect the concentration. The temperature electrode may be configured to be disposed on the substrate and detect the temperature. The reference electrode may be configured to be disposed on the substrate and maintain a reference electric potential. The reference electrode may be disposed at least between two of the level electrode, the electrode for liquid quality and the temperature electrode.

In this sensor device, the three electrodes, namely the level electrode, the electrode for liquid quality, and the temperature electrode, are disposed on one substrate. Thus, the size of the sensor device may decrease as compared to a configuration where the level electrode, the electrode for liquid quality, and the temperature electrode are distributed to and disposed on a plurality of substrates.

Moreover, the reference electrode is disposed at least between two of the level electrode, the electrode for liquid quality, and the temperature electrode. Thus, the occurrence of an unnecessary electrostatic capacitance (stray capacitance or parasitic capacitance) between these two electrodes due to an electric potential difference between the two electrodes that interpose the reference electrode may be suppressed. As a result, a detection error may be decreased. According to this configuration, the electrodes for specifying the level of liquid, the concentration of a specific substance in the liquid, and the temperature of the liquid may be appropriately disposed on one substrate.

### BRIEF DESCRIPTION OF THE DRAWINGS

FIG. 1 shows an outline of a sensor system according to a first embodiment.

FIG. 2 shows a sensor device according to a second embodiment.

FIG. 3 shows a sensor device according to a third embodiment.

FIG. 4 shows a sensor device according to a fourth embodiment.

FIG. 5 shows a sensor device according to a fifth embodiment.

### DETAILED DESCRIPTION

Some features of the sensor device disclosed herein will be described. In the sensor device disclosed herein, a level electrode, an electrode for liquid quality or a combination thereof and a reference electrode may be disposed adjacently. In this configuration, when a signal is supplied to the specific electrode, electric charge may be stored between the specific electrode and the reference electrode. Thus, the level or the concentration may be specified using the electrostatic capacitance between the specific electrode and the reference electrode. According to this configuration, the reference electrode for suppressing a stray capacitance may be used for specifying the level or the concentration. Therefore, it is not necessary to provide an electrode corresponding to the specific electrode on the substrate in addition to the reference electrode.

A temperature detecting element configured to connect with the temperature electrode at one end of the temperature detecting element may further be comprised. The reference electrode may connect with another end of the temperature detecting element. According to this configuration, it is not necessary to provide a temperature detecting element electrode on the substrate in addition to the reference electrode. The temperature detecting clement may be a thermistor, for example.

The level electrode, the electrode for liquid quality, the temperature electrode and the reference electrode may extend on the substrate from an upper side of the substrate toward a lower side of the substrate. A part of the electrode for liquid quality may be disposed lower than the level electrode. A lower part of the reference electrode may be disposed between the temperature electrode and the part of the electrode for liquid quality. Further, an upper part of the reference electrode may be disposed between the temperature electrode and the level electrode. In this configuration, when a signal is supplied to the level electrode, electric charge may be stored between the level electrode and the reference electrode. When a signal is supplied to the electrode for liquid quality, electric charge may be stored between the electrode for liquid quality and the reference electrode. According to this configuration, the reference electrode performs the functions of three electrodes of the electrode corresponding to the level electrode, the electrode corresponding to the electrode for liquid quality, and the electrode for the reference electrode. Since the number of electrodes provided on the substrate may be decreased, the size of the sensor device may be decreased.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved sensor device.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

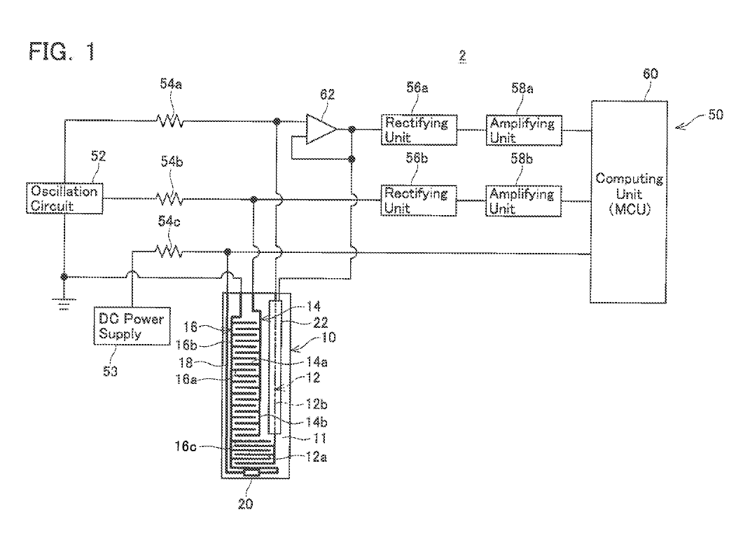

As shown in FIG. 1, a sensor system 2 comprises a sensor device 10 and a specifying device 50. The sensor system 2 is mounted on an automobile that uses blended fuel of gasoline and ethanol as its fuel.

The sensor device 10 comprises a substrate 11, an electrode for liquid quality 12, a level electrode 14, a reference electrode 16, a thermistor electrode 18, a thermistor 20, and a shield electrode 22. The substrate 11 is a rectangular fiat plate. The respective units 12, 14, 16, 18, 20, and 22 are disposed on one surface of the substrate 11.

The electrode for liquid quality 12 comprises a plurality of (e.g., three in FIG. 1) first electrode portions 12a (only one of the first electrode portions 12a is denoted by a reference numeral in FIG. 1) and a second electrode portion 12b. The second electrode portion 12b extends linearly in a longitudinal direction (i.e., a depth direction of a fuel tank) of the substrate 11. An upper end of the second electrode portion 12b is positioned at an upper end of the substrate 11. The second electrode portion 12b is connected to one set of ends (i.e., the right ends in FIG. 1) of the plurality of first electrode portions 12a. Doe to this, the plurality of first electrode portions 12a is electrically connected to the second electrode portion 12b. The plurality of first electrode portions 12a is disposed in parallel to each other and is disposed vertically to the second electrode portion 12b. The plurality of first electrode portions 12a is disposed at an equal interval in the longitudinal direction of the substrate 11. The lower end of the electrode for liquid quality 12 is disposed at least 1.0 cm above from the lower end of the substrate 11.

A portion of the second electrode portion 12b located on the upper side than the uppermost one of the first electrode portions 12a is covered by the shield electrode 22. In other words, the second electrode portion 12b is interposed between the substrate 11 and the shield electrode 22. The shield electrode 22 covers a portion of the second electrode portion 12b that extends from the vicinity of the upper end of the substrate 11 to the vicinity of a portion that is connected to the uppermost one of the first electrode portions 12a.

The level electrode 14 is disposed on the left side of the electrode for liquid quality 12. The level electrode 14 is disposed on the upper side than the first electrode portion 12a of the electrode for liquid quality 12. That is, the level electrode 14 is disposed in the vicinity of the portion of the second electrode portion 12b of the electrode for liquid quality 12 that is covered by the shield electrode 22.

The level electrode 14 comprises a plurality of (e.g., ten in FIG. 1) first electrode portions 14a (only one of the first electrode portions 14a is denoted by a reference numeral in FIG. 1) and a second electrode portion 14b. The second electrode portion 14b extends in the longitudinal direction of the substrate 11. The second electrode portion 14b is disposed in parallel to the second electrode portion 12b of the electrode for liquid quality 12. The upper end of the second electrode portion 14b is positioned at the upper end of the substrate 11. The second electrode portion 14b is connected to one set of ends (i.e., the right ends in FIG. 1) of the plurality of first electrode portions 14a. Due to this, the plurality of first electrode portions 14a is electrically connected to the second electrode portion 14b. The plurality of first electrode portions 14a is disposed in parallel to each other and is disposed vertically to the second electrode portion 14b. That is, the plurality of first electrode portions 14a is disposed in parallel to the first electrode portion 12a of the electrode for liquid quality 12. The plurality of first electrode portions 14a is disposed at an equal interval in the longitudinal direction of the substrate 11.

The reference electrode 16 is disposed on the left side of the level electrode 14. The reference electrode 16 comprises a plurality of (e.g., ten in FIG. 1) third electrode portions 16a (only one of the third electrode portions 16a is denoted by a reference numeral in FIG. 1), a plurality of (e.g., three in FIG. 1) fourth electrode portions 16c, and a fifth electrode portion 16b. The fifth electrode portion 16b extends in the longitudinal direction of the substrate 11. The upper end of the fifth electrode portion 16b is positioned at the upper end of the substrate 11. The fifth electrode portion 16b is connected to one set of ends (i.e., the left ends in FIG. 1) of the plurality of third electrode portions 16a and the plurality of fourth electrode portions 16c. Due to this, the plurality of third electrode portions 16a and the plurality of fourth electrode portions 16c are electrically connected to the fifth electrode portion 16b.

The plurality of third electrode portions 16a is disposed in a range where the third electrode portions 16a overlap the level electrode 14 in the vertical direction of the substrate 11. The plurality of third electrode portions 16a is disposed in parallel to each other and is disposed vertically to the fifth electrode portion 16b. The plurality of third electrode portions 16a is disposed at an equal interval in the longitudinal direction of the substrate 11. When seen along a line extending from the upper end to the lower end of the substrate 11, the third electrode portion 16a and the first electrode portion 14a are disposed alternately.

The plurality of fourth electrode portions 16c is disposed on the lower side than the plurality of third electrode portions 16a and the level electrode 14 in the longitudinal direction of the substrate 11. The plurality of fourth electrode portions 16c is disposed in parallel to each other and is disposed vertically to the fifth electrode portion 16b. The plurality of fourth electrode portions 16c is disposed at an equal interval in the longitudinal direction of the substrate 11. When seen along a line extending from the upper end to the lower end of the substrate 11, the fourth electrode portion 16c and the first electrode portion 12a are disposed alternately.

The fifth electrode portion 16b extends further downward than the lowermost one of the fourth electrode portions 16c and the lowermost one of the first electrode portions 12a. The lower end of the fifth electrode portion 16b extends rightward in parallel to the plurality of fourth electrode portions 16c. The right end of the fifth electrode portion 16b extends over the second electrode portion 12b of the electrode for liquid quality 12 and reaches the vicinity of the right end of the substrate 11. The fifth electrode portion 16b is folded at the right end thereof and extends toward the left side.

The fifth electrode portion 16b is connected to the thermistor 20 at the vicinity of the lower end of the substrate 11. That is, the thermistor 20 is disposed on the lower side than the electrode for liquid quality 12 and the level electrode 14, The thermistor electrode 18 is connected to a side (i.e., the left side) of the thermistor 20 opposite to a side where the fifth electrode portion 16b is connected. The thermistor electrode 18 extends leftward from the thermistor 20 and then extends from the lower side to the upper side. The upper end of the thermistor electrode 18 is positioned at the upper end of the substrate 11. The thermistor electrode 18 is disposed on the left side of the fifth electrode portion 16b.

An upper portion of the fifth electrode portion 16b is disposed between the level electrode 14 and the thermistor electrode 18. A lower portion of the fifth electrode portion 16b is disposed between the electrode for liquid quality 12 and the thermistor electrode 18. In a range of portions where the level electrode 14 is disposed in the longitudinal direction of the substrate 11, the electrode for liquid quality 12, the level electrode 14, the fifth electrode portion 16b, and the thermistor electrode 18 are arranged in that order from the right end of the substrate 11.

In a case where the sensor device 10 is disposed in the fuel tank, the lower end of the substrate 11 is disposed to be in contact with the lower surface of the fuel tank. As a result, the thermistor 20 is positioned near the bottom portion of the fuel tank. The lower end of the electrode for liquid quality 12 is positioned at least 1.0 cm above from the lower surface of the fuel tank. In general, the first electrode portion 12a and the fourth electrode portion 16c are immersed in the fuel in the fuel tank.

The specifying device 50 comprises an oscillation circuit 52, a DC power supply 53, three resistors 54a to 54c, two rectifying units 56a and 56b, two amplifying units 58a and 58b, a computing unit 60, and an operational amplifier 62. The oscillation circuit 52 generates a signal (e.g., AC voltage) of a predetermined frequency (e.g., 10 Hz to 50 kHz).

The oscillation circuit 52 is connected to the upper end of the electrode for liquid quality 12 via the resistor 54a and the upper end of the level electrode 14 via the resistor 54b. According to this configuration, since the resistance values of the two resistors 54a and 54b can be set individually, it is possible to individually adjust the amplitudes (e.g., the magnitudes of voltage) of the signals supplied to the respective electrodes 12 and 14. Moreover, the oscillation circuit 52 is connected to the upper end of the shield electrode 22 via the resistor 54a and the operational amplifier 62. The DC power supply 53 is connected to the upper end of the thermistor electrode 18 via the resistor 54c.

The upper end of the fifth electrode portion 16b of the reference electrode 16 is connected to the ground electric potential. When a signal (DC voltage) is supplied from the DC power supply 53 to the thermistor electrode 18, the signal is supplied to the thermistor 20. The resistance value of the thermistor 20 changes in correlation with the temperature of the fuel. Since the resistance value of the resistor 54c is constant, the amplitude of the signal supplied to the thermistor 20, that is, the signal supplied to the thermistor electrode 18 changes in correlation with the temperature of the fuel.

In a case where a signal is supplied from the oscillation circuit 52 to the electrode for liquid quality 12, electric charge is stored between the electrode for liquid quality 12 and the reference electrode 16, mainly between the first electrode portion 12a and the fourth electrode portion 16c. The electrostatic capacitance between the electrode for liquid quality 12 and the reference electrode 16 is correlated with the concentration of ethanol in the fuel. That is, the concentration of ethanol in the fuel is detected in a range of portions where the first electrode portion 12a and the fourth electrode portion 16c are positioned. Further, the electrostatic capacitance between the electrode for liquid quality 12 and the reference electrode 16 is correlated with the temperature of the fuel. Since the resistance value of the resistor 54b is constant, the amplitude of the signal supplied to the electrode for liquid quality 12 changes in correlation with the temperature of the fuel and the concentration of the ethanol.

Moreover, In a case where a signal is supplied from the oscillation circuit 52 to the electrode for liquid quality 12, a signal amplified by the operational amplifier 62 is also supplied to the shield electrode 22. The signal supplied to the shield electrode 22 and the signal supplied to the electrode for liquid quality 12 have the same frequency. As a result, the electric potential difference between the shield electrode 22 and the electrode for liquid quality 12 is maintained to be constant. The electrostatic capacitance between the shield electrode 22 and the electrode for liquid quality 12 is correlated with the level of the fuel in the fuel tank. However, the amount of the change relative to the level, of the electrostatic capacitance between the shield electrode 22 and the electrode for liquid quality 12 is negligibly small as compared to the electrostatic capacitance between the electrode for liquid quality 12 and the reference electrode 16.

In a case where a signal is supplied from the oscillation circuit 52 to the level electrode 14, electric charge is stored between the level electrode 14 and the reference electrode 16, mainly between the first electrode portion 14a and the third electrode portion 16a. The electrostatic capacitance between the level electrode 14 and the reference electrode 16 is correlated with the length of a portion of the level electrode 14 immersed in the fuel, that is the level of the fuel in the fuel tank. That is, the level of the fuel is detected in a range of portions where the first electrode portion 14a and the third electrode portion 16a are positioned. Further, the electrostatic capacitance between the level electrode 14 and the reference electrode 16 is correlated with the concentration (i.e., the permittivity of the fuel) of the ethanol in the fuel. Since the resistance value of the resistor 54b is constant, the amplitude of the signal supplied to the level electrode 14 changes in correlation with the level of the fuel and the concentration of the ethanol.

The rectifying unit 56a is directly connected between the resistor 54a and the electrode for liquid quality 12. When a signal is supplied from the oscillation circuit 52 to the electrode for liquid quality 12, the same signal as the signal input to the electrode for liquid quality 12 is input to the rectifying unit 56a. The rectifying unit 56a rectifies the input signal and outputs the rectified signal to the amplifying unit 58a. The amplifying unit 58a amplifies the input signal and outputs the amplified signal to the computing unit (i.e., MCU) 60.

Similarly, the rectifying unit 56b is connected between the resistor 54b and the level electrode 14. In a case where a signal is supplied from the oscillation circuit 52, the same signal as the signal input to the level electrode 14 is input to the rectifying unit 56b. As a result, a signal which is rectified by the rectifying unit 56b and amplified by the amplifying unit 58b is input to the computing unit 60.

The computing unit 60 is connected between the resistor 54c and the thermistor electrode 18. In a case where a signal is supplied from the DC power supply 53, the same signal as the signal input to the thermistor electrode 18 (i.e., the thermistor 20) is input to the computing unit 60. A signal of the DC voltage from the DC power supply 53 is input to the thermistor electrode 18 and the computing unit 60. Thus, it is not necessary to dispose a rectifying unit and an amplifying unit between the DC power supply 53 and the computing unit 60. According to this configuration, it is not necessary to process the signal input to the computing unit 60 as compared to a case where a signal of an AC voltage is supplied to the thermistor electrode 18.

The computing unit 60 stores a temperature database, an ethanol concentration database, and a level database in advance. The temperature database shows a correlation between the signal correlated with the signal input to the thermistor 20 and the temperature of the blended fuel. The ethanol concentration database shows a correlation between the signal input from the amplifying unit 58a, that is the signal correlated with the signal input to the electrode for liquid quality 12, the temperature of the blended fuel, and the concentration of the ethanol included in the blended fuel. The level database shows a correlation between the concentration (i.e., the permittivity of fuel) of the ethanol included in the blended fuel and the signal input from the amplifying unit 58b, that is the signal correlated with the signal input to the level electrode 14. The computing unit 60 may store mathematical formula for calculating the temperature or the like of the blended fuel using the input signals instead of storing the respective databases.

In the sensor device 10, the fifth electrode portion 16b of the reference electrode 16 is disposed on the substrate 11 between the electrode for liquid quality 12 and the thermistor electrode 18. The upper end of the fifth electrode portion 16b is connected to the ground electric potential, and the lower end of the fifth electrode portion 16b is connected to the thermistor electrode 18 via the thermistor 20. Since the resistance value of the fifth electrode portion 16b is sufficiently smaller than the resistance value of the thermistor 20, the electric potential of the fifth electrode portion 16b is maintained to be constant (i.e., 0 V) when a signal is supplied from the DC power supply 53 to the thermistor electrode 18.

Therefore, even if a signal is concurrently supplied to the sensor device 10 from the oscillation circuit 52 and the DC power supply 53, since the fifth electrode portion 16b is disposed between the electrode for liquid quality 12 and the thermistor electrode 18, electric charge is suppressed from being stored between the electrode for liquid quality 12 and the thermistor electrode 18 due to the electric potential difference between the electrode for liquid quality 12 and the thermistor electrode 18 (i.e., the occurrence of a stray capacitance is suppressed).

Similarly, in the sensor device 10, the fifth electrode portion 16b of the reference electrode 16 is disposed on the substrate 11 between the level electrode 14 and the thermistor electrode 18. As a result, electric charge is suppressed from being stored between the level electrode 14 and the thermistor electrode 18 due to the electric potential difference between the level electrode 14 and the thermistor electrode 18 (i.e., the occurrence of a stray capacitance is suppressed). According to this configuration, the electrodes 12, 14, and 18 for specifying the level of fuel, the concentration of ethanol in the fuel, and the temperature of the fuel are appropriately disposed on one substrate 11.

In the sensor device 10, the level of fuel and the concentration of ethanol are specified using the electrostatic capacitance between the fifth electrode portion 16b and the electrode for liquid quality 12 and the electrostatic capacitance between the fifth electrode portion 16b and the level electrode 14. According to this configuration, the fifth electrode portion 16b for suppressing the occurrence of a stray capacitance can be used as a ground electrode corresponding to the respective electrodes 12 and 14. Therefore, it is not necessary to provide the ground electrode corresponding to the respective electrodes 12 and 14 on the substrate 11 in addition to the reference electrode 16, and the size of the sensor device 10 can be decreased.

Moreover, the thermistor 20 is disposed between the fifth electrode portion 16b of the reference electrode 16 and the thermistor electrode 18. The fifth electrode portion 16b that suppresses the occurrence of a stray capacitance can be used as an electrode for grounding the thermistor 20. Therefore, it is not necessary to provide an electrode for grounding the thermistor 20 on the substrate 11 in addition to the reference electrode 16, and the size of the sensor device 10 can be decreased.

That is, the reference electrode 16 performs the three functions of suppressing ₜhe occurrence of a stray capacitance, serving as the ground electrode corresponding to the respective electrodes 12 and 14, and grounding the thermistor 20. In this manner, by allowing one reference electrode 16 to serve a plurality of functions, it is possible to decrease the number of electrodes provided on the substrate 11.

### Second Embodiment

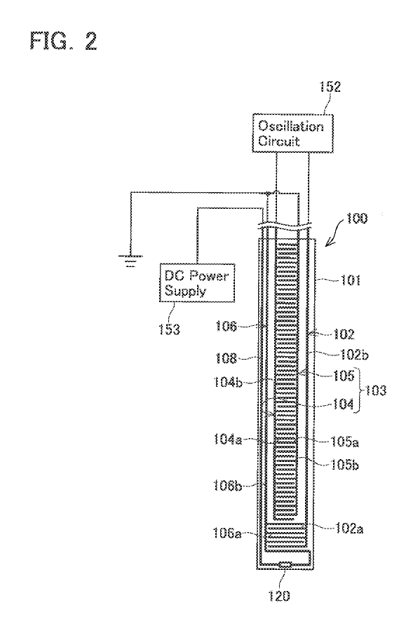

A sensor device 100 shown in FIG. 2 comprises a substrate 101, a electrode for liquid quality 102, a level electrode pair 103, a reference electrode 106, a thermistor electrode 108, and a thermistor 120. The substrate 101, the electrode for liquid quality 102, and the thermistor electrode 108 have the same configurations as those of the substrate 11, the electrode for liquid quality 12, and the thermistor electrode 18 of FIG. 1, respectively. That is, the electrode for liquid quality 102 comprises electrode portions 102a and 102b similarly to the respective electrode portions 12a and 12b of the electrode for liquid quality 12. The electrode for liquid quality 102 is connected to an oscillation circuit 152 via a resistor (not shown). The thermistor electrode 108 is connected to a DC power supply 153.

The level electrode pair 103 is disposed on the left side of the electrode for liquid quality 102. The level electrode pair 103 is disposed on the upper side than the first electrode portion 102a of the electrode for liquid quality 102. The level electrode pair 103 comprises a level electrode 104 and a reference electrode 105.

When seen along the horizontal direction of the substrate 101, the reference electrode 105 is disposed between the level electrode 104 and the electrode for liquid quality 102. That is, the reference electrode 105 is disposed on the left side of the electrode for liquid quality 102 and is disposed on the right side of the level electrode 104.

The level electrode 104 comprises a plurality of (e.g., thirty one in FIG. 2) first electrode portions 104a (only one of the first electrode portions 104a is denoted by a reference numeral in FIG. 2) and a second electrode portion 104b. The second electrode portion 104b extends in the longitudinal direction of the substrate 101. That is, the second electrode portion 104b is disposed in parallel to the second electrode portion 102b of the electrode for liquid quality 102. The plurality of first electrode portions 104a is electrically connected to the second electrode portion 104b. The plurality of first electrode portions 104a is disposed in parallel to each other and is disposed vertically to the second electrode portion 104b. That is, the plurality of first electrode portions 104a is disposed in parallel to the first electrode portion 102a of the electrode for liquid quality 102. The plurality of first electrode portions 104a is disposed at an equal interval in the longitudinal direction of the substrate 101. The level electrode 104 is connected to the oscillation circuit 152 via a resistor (not shown).

The reference electrode 105 comprises a plurality of (e.g., thirty one in FIG. 2) first electrode portions 105a (only one of the first electrode portions 105a is denoted by a reference numeral in FIG. 2) and a second electrode portion 105b. The second electrode portion 105b extends in the longitudinal direction of the substrate 101. That is, the second electrode portion 105b is disposed in parallel to the second electrode portion 104b. The plurality of first electrode portions 105a is electrically connected to the second electrode portion 105b. The plurality of first electrode portions 105a is disposed in parallel to each other and is disposed vertically to the second electrode portion 105b. The plurality of first electrode portions 105a is disposed at an equal interval in the longitudinal direction of the substrate 101. When seen along a line extending from the upper end to the lower end of the substrate 101, the first electrode portion 104a and the first electrode portion 105a are disposed alternately. The reference electrode 105 is connected to the ground electric potential.

The reference electrode 106 is disposed on the left side of the level electrode pair 103. The reference electrode 106 comprises a plurality of (e.g., three in FIG. 2) fourth electrode portions 106a (corresponding to the fourth electrode portions 16c of the reference electrode 16) and a fifth electrode portion 106b similarly to the reference electrode 16 of FIG. 1. The reference electrode 106 does not comprise an electrode portion that corresponds to the third electrode portion 16a of FIG. 1. The reference electrode 106 is connected to the ground electric potential.

In the sensor device 100, similarly to the sensor device 10 of FIG. 1, the reference electrode 106 is disposed on the substrate 101 between the electrode for liquid quality 102 and the thermistor electrode 108. Further, the reference electrode 106 is disposed between the level electrode 104 and the thermistor electrode 108. Thus, it is possible to suppress the occurrence of a stray capacitance between the electrode for liquid quality 102 and the thermistor electrode 108 and between the level electrode 104 and the thermistor electrode 108. According to this configuration, the electrodes 102, 104, and 108 for specifying the level of fuel, the concentration of ethanol in the fuel, and the temperature of the fuel are appropriately disposed on one substrate 101.

Moreover, in the sensor device 100, the reference electrode 105 is disposed on the substrate 101 between the electrode for liquid quality 102 and the level electrode 104. As a result, it is possible to suppress the occurrence of an electrostatic capacitance (i.e., stray capacitance) between the electrode for liquid quality 102 and the level electrode 104 due to an electric potential difference between the electrode for liquid quality 102 and the level electrode 104.

In the sensor device 100, the property of fuel (i.e., the concentration of ethanol) is specified based on the electrostatic capacitance between the reference electrode 106 and the electrode for liquid quality 102. Moreover, the thermistor 120 is disposed between the fifth electrode portion 106b of the reference electrode 106 and the thermistor electrode 108. Thus, it is not necessary to provide a ground electrode corresponding to the electrode for liquid quality 102 and an electrode for grounding the thermistor 120 on the substrate 101 in addition to the reference electrode 106, and the size of the sensor device 100 can be decreased.

### Third Embodiment

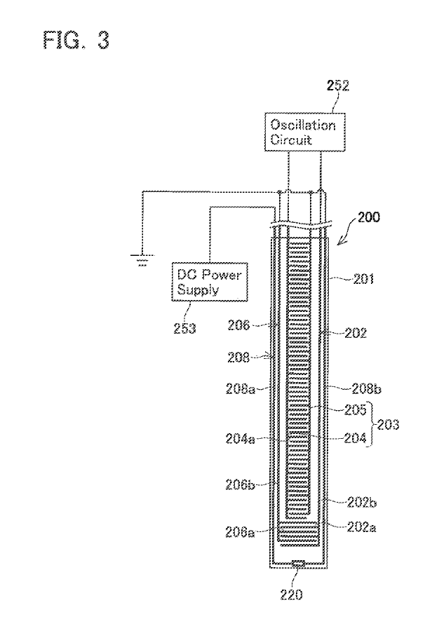

A sensor device 200 shown in FIG. 3 comprises a substrate 201, a electrode for liquid quality 202, a level electrode pair 203, a reference electrode 206, a thermistor 220, and a thermistor electrode pair 208. The substrate 201, the electrode for liquid quality 202, and the level electrode pair 203 have the same configurations as those of the substrate 101, the electrode for liquid quality 102, and the level electrode pair 103 of FIG. 2, respectively. That is, the electrode for liquid quality 202 comprises electrode portions 202a and 202b similarly to the respective electrode portions 102a and 102b of the electrode for liquid quality 102. The electrode for liquid quality 202 is connected to an oscillation circuit 252 via a resistor (not shown). The level electrode pair 203 comprises electrodes 204 (i.e., electrode portions 204a and 204b) and 205 (i.e., electrode portions 205a and 205b) similarly to the respective electrodes 104 (i.e., the electrode portions 104a and 104b) and 105 (i.e., the electrode portions 105a and 105b) of the level electrode pair 103. The level electrode 204 is connected to the oscillation circuit 252 via a resistor (not shown). The reference electrode 205 is connected to the ground electric potential.

The reference electrode 206 is disposed on the left side of the level electrode pair 203. The reference electrode 206 comprises a plurality of (e.g., three in PEG. 3) fourth electrode portions 206a (only one of the fourth electrode portions 206a is denoted by a reference numeral in FIG. 3) and a fifth electrode portion 206b. The fifth electrode portion 206b extends in the longitudinal direction of the substrate 201. That is, the fifth electrode portion 206b is disposed in parallel to the second electrode portion 202b. The plurality of fourth electrode portions 206a is electrically connected to the fifth electrode portion 206b. The plurality of fourth electrode portions 206a is disposed in parallel to each other and is disposed vertically to the fifth electrode portion 206b. The plurality of fourth electrode portions 206a is disposed at an equal interval in the longitudinal direction of the substrate 201. When seen along a line extending from the upper end to the lower end of the substrate 201, the first electrode portion 202a and the fourth electrode portion 206a are disposed alternately. The reference electrode 206 is connected to the ground electric potential.

The thermistor electrode pair 208 comprises a thermistor electrode 208a connected to a DC power supply 253 and a reference electrode 208b that is grounded. The thermistor electrode 208a is disposed on the left side of the reference electrode 206 and extends in the longitudinal direction of the substrate 201. The lower end of the thermistor electrode 208a is connected to the thermistor 220. The reference electrode 208b is disposed on the right side of the electrode for liquid quality 202 and extends in the longitudinal direction of the substrate 201. The lower end of the reference electrode 208b is connected to the thermistor 220.

In a range of portions where the level electrode pair 203 is disposed in the vertical direction of the substrate 201, the ground electrode 208b, the electrode for liquid quality 202, the reference electrode 205, the level electrode 204, the reference electrode 206, and the thermistor electrode 208a are arranged in that order from the right end of the substrate 201. According to this configuration, similarly to the sensor devices 10 and 100, the electrodes 202, 204, and 208 for specifying the level of fuel, the concentration of ethanol in the fuel, and the temperature of the fuel are appropriately disposed on one substrate 201.

### Fourth Embodiment

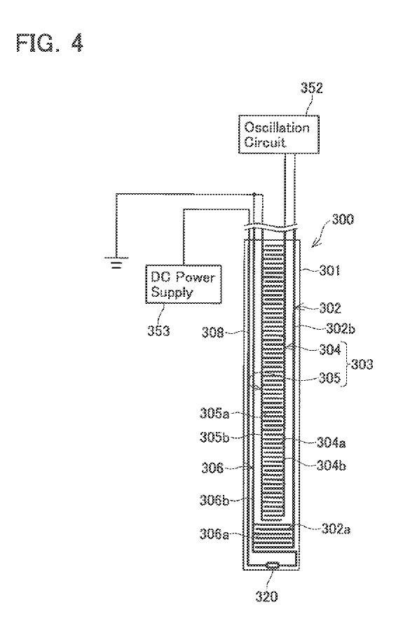

A sensor device 300 shown in FIG. 4 comprises a substrate 301, an electrode for liquid quality 302, a level electrode pair 303, a reference electrode 306, a thermistor electrode 308, and a thermistor 320. The substrate 301, the electrode for liquid quality 302, the reference electrode 306, and the thermistor electrode 308 have the same configurations as those of the substrate 101, the electrode for liquid quality 102, the reference electrode 106, and the thermistor electrode 108 of FIG. 2, respectively. That is, the electrode for liquid quality 302 comprises electrode portions 302a and 302b similarly to the respective electrode portions 102a and 102b of the electrode for liquid quality 102. The electrode for liquid quality 302 is connected to an oscillation circuit 352 via a resistor (not shown). Moreover, the reference electrode 306 comprises electrode portions 306a and 306b similarly to the respective electrode portions 106a and 106b of the reference electrode 106. The reference electrode 306 is connected to the ground electric potential. The thermistor electrode 308 is connected to a DC power supply 353.

The level electrode pair 303 is disposed on the left side of the electrode for liquid quality 302. The level electrode pair 303 is disposed on the upper side than the first electrode portion 302a of the electrode for liquid quality 302. The level electrode pair 303 comprises a level electrode 304 and a reference electrode 305.

The level electrode pair 303 has the same configuration as the level electrode pair 103 except that the level electrode pair 303 has a symmetric structure with respect to the level electrode pair 103 of FIG. 2 (specifically, the level electrode pair 103 of FIG. 2 has a structure such that the reference electrode 105 is on the right side and the level electrode 104 is on the left side, whereas the level electrode pair 303 has a structure such that the reference electrode 305 is on the left side and the level electrode 304 is on the right side). That is, the level electrode 304 is disposed on the left side of the electrode for liquid quality 302, and the reference electrode 305 is disposed between the level electrode 304 and the reference electrode 306.

The level electrode 304 comprises electrode portions 304a and 304b similarly to the respective electrode portions 104a and 104b of the level electrode 104. The level electrode 304 is connected to the oscillation circuit 352 via a resistor (not shown). The reference electrode 305 comprises electrode portions 305a and 305b similarly to the respective electrode portions 105a and 105b of the reference electrode 105. The reference electrode 305 is connected to the ground electric potential.

In the sensor device 300, the reference electrode 306 is disposed on the substrate 301 between the electrode for liquid quality 302 and the thermistor electrode 308. Thus, it is possible to suppress the occurrence of a stray capacitance between the electrode for liquid quality 302 and the thermistor electrode 308. According to this configuration, the respective electrodes 302 and 308 can be appropriately disposed on one substrate 301. Moreover, in the sensor device 300, two reference electrodes 305 and 306 are disposed on the substrate 301 between the level electrode 304 and the thermistor electrode 308. Thus, it is possible to suppress the occurrence of a stray capacitance between the level electrode 304 and the thermistor electrode 308. According to this configuration, the respective electrodes 304 and 308 can be appropriately disposed on one substrate 301.

### Fifth Embodiment

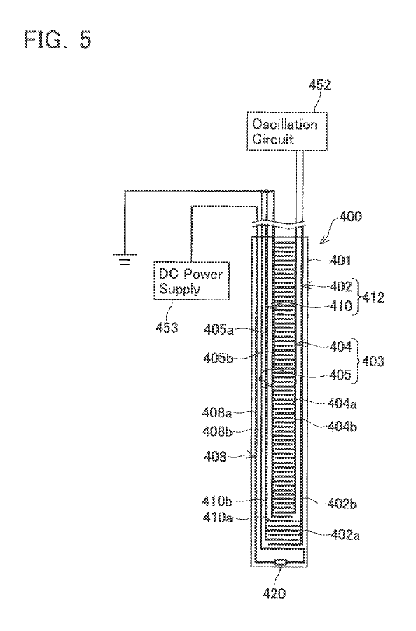

A sensor device 400 shown in FIG. 5 comprises a substrate 401, an electrode for liquid quality pair 412, a level electrode pair 403, a thermistor electrode pair 408, and a thermistor 420. The substrate 401 and the level electrode pair 403 have the same configurations as those of the substrate 301 and the level electrode pair 303 of FIG. 4, respectively. That is, the level electrode pair 403 comprises electrodes 404 (electrode portions 404a and 404b) and 405 (electrode portions 405a and 405b) similarly to the respective electrodes 304 (the electrode portions 304a and 304b) and 305 (the electrode portions 305a and 305b) of the level electrode pair 303. The level electrode 404 is connected to an oscillation circuit 452 via a resistor (not shown). The reference electrode 405 is connected to the ground electric potential.

The electrode for liquid quality pair 412 comprises an electrode for liquid quality 402 and a reference electrode 410. The electrode for liquid quality 402 comprises electrode portions 402a and 402b similarly to the respective electrode portions 302a and 302b of the electrode for liquid quality 302 of FIG. 4. The electrode for liquid quality 402 is connected to the oscillation circuit 452 via a resistor (not shown). The reference electrode 410 comprises electrode portions 406a and 406b similarly to the respective electrode portions 206a and 206b of the reference electrode 206 of FIG. 3. The reference electrode 406 is connected to the ground electric potential.

The electrode for liquid quality 402 is disposed on the right side of the level electrode pair 403, and the reference electrode 410 is disposed on the left side of the level electrode pair 403. Specifically, a second electrode portion 402b of the electrode for liquid quality 402 is disposed on the right side of the level electrode pair 403, and a fourth electrode portion 410b of the reference electrode 410 is disposed on the left side of the level electrode pair 403. A first electrode portion 402a and a third electrode portion 410a are positioned on the lower side of the level electrode pair 403.

The thermistor electrode pair 408 is disposed on the left side of the electrode for liquid quality pair 412. The thermistor electrode pair 408 comprises a thermistor electrode 408a and a reference electrode 408b. The thermistor electrode 408a has the same configuration as the thermistor electrode 18 of FIG. 1. The thermistor electrode 408a is connected to a DC power supply 453. The reference electrode 408h is connected to the right side of the thermistor 420, and passes between the reference electrode 410 and the thermistor electrode 408a to reach the upper end of the substrate 401. The reference electrode 408b is connected to the ground electric potential. That is, three reference electrodes 405, 410, and 408b which are connected to the ground electric potential are disposed between the level electrode 404 connected to the oscillation circuit 453 and the thermistor electrode 408a connected to the DC power supply 453.

In the sensor device 400, the same advantages as those of the sensor device 300 can be obtained.

(Modifications)

(1) In the first embodiment, the sensor device 10 comprises the shield electrode 22. However, the sensor device 10 may not comprise the shield electrode 22, Moreover, for example, in the first embodiment, the thermistor electrode 18 is connected to the DC power supply 53. However, the thermistor electrode 18 may be connected to the oscillation circuit 52 similarly to the level electrode 12. The same modification is applied to the second and third embodiments.

(2) The reference electrodes 16 and 106 and the reference electrodes 105, 205, 206, and 208b may be not connected to the ground electric potential. For example, these electrodes may be connected to a portion which is maintained at a constant electric potential.

(3) A temperature detecting element such as a platinum resistance temperature detector in which the output characteristics such as current change with a temperature may be used instead of the thermistor 20 or the like.

(4) In the first, fourth, and fifth embodiments, the reference electrode 16 and the like that are connected to the ground electric potential are disposed between the level electrode 14 and the like connected to the oscillation circuit 52 or the like and the thermistor electrode 18 and the like connected to the DC power supply 53 or the like. In the second and third embodiments, the reference electrode 105 and the like that are connected to the ground electric potential are disposed between the electrode for liquid quality 102 and the like connected to the oscillation circuit 152 or the like and the level electrode 104 and the like connected to the oscillation circuit 152 or the like. Further, in the second and third embodiments, the reference electrode 106 and the like that are connected to the ground electric potential are disposed between the level electrode 104 and the like connected to the oscillation circuit 152 or the like and the thermistor electrode 108 and the like connected to the DC power supply 153 or the like. In addition to these configuration, for example, a reference electrode that is connected to the ground electric potential may be disposed between an electrode for liquid quality connected to the oscillation circuit and a level electrode connected to the oscillation circuit, and the reference electrode 106 and the like may be not disposed between a level electrode connected to the oscillation circuit and a thermistor electrode connected to the DC power supply. in general, when a level electrode, an electrode for liquid quality, and a thermistor electrode to which power is supplied from the outside are disposed on one surface of one substrate, the reference electrode may be disposed at least between two of the level electrode, the electrode for liquid quality, and the thermistor electrode.

The number of reference electrodes (i.e., grounded electrodes) disposed between two of the level electrode, the electrode for liquid quality, and the thermistor electrode is not particularly limited.

1. A sensor device configured to detect a level of liquid, a concentration of a specific substance included in the liquid, and a temperature of the liquid, the sensor device comprising:
a substrate;
a level electrode configured to be disposed on the substrate and detect the level;
an electrode for liquid quality configured to be disposed on the substrate and detect the concentration;
a temperature electrode configured to be disposed on the substrate and detect the temperature; and
a reference electrode configured to be disposed on the substrate and maintain a reference electric potential, wherein
the reference electrode is disposed at least between Iwo of the level electrode, the electrode for liquid quality and the temperature electrode.

2. The sensor device as in claim 1, wherein
the level electrode, the electrode for liquid quality or a combination thereof and the reference electrode are disposed adjacently.

3. The sensor device as in claim 1, further comprising:
a temperature detecting element configured to connect with the temperature electrode at one end of the temperature detecting element, wherein
the reference electrode connects with another end of the temperature detecting clement.

4. The sensor device as in claim 1, wherein
the level electrode, the electrode for liquid quality, the temperature electrode and the reference electrode extend on the substrate from an upper side of the substrate toward a lower side of the substrate,
a part of the electrode for liquid quality is disposed lower than the level electrode,
a lower part of the reference electrode is disposed between the temperature electrode and the part of the electrode for liquid quality, and
an upper part of the reference electrode is disposed between the temperature electrode and the level electrode.
